(19) United States
(12) Patent Application Publication
(10) Pub. No.: US 2014/0348428 A1
(43) Pub. Date: Nov. 27, 2014

(54) DYNAMIC RANGE-ADJUSTMENT APPARATUSES AND METHODS

(71) Applicant: Himax Media Solutions, Inc., Tainan City (TW)

(72) Inventor: Kun-Hsien Lee, Tainan City (TW)

(73) Assignee: HIMAX MEDIA SOLUTIONS, INC., Tainan City (TW)

(21) Appl. No.: 13/902,002

(22) Filed: May 24, 2013

(51) Int. Cl. G06T 5/40; G06T 7/00

(52) U.S. Cl. CPC G06T 5/40; G06T 7/0081
USPC 382/169

(57) ABSTRACT

A dynamic range-adjustment apparatus is provided. The apparatus includes: an input unit for receiving an original image; an histogram equalization unit, coupled to the input unit, for performing contrast enhancement on the original image to produce a contrast-enhanced image; a factor-determination unit, coupled to the input unit and the histogram equalization unit, for determining a first factor based on the gray level of a pixel of the original image and the tone of the corresponding pixel of the contrast-enhanced image; and an adjustment unit, coupled to the input unit, the histogram equalization unit and the factor-determination unit.

### BACKGROUND OF THE INVENTION

1. Field of the Invention

The present invention relates to image-processing technology, and in particular to dynamic range-adjustment technology.

2. Description of the Related Art

The human visual range becomes narrower as sunlight gets stronger. Therefore, it is difficult for the human eye to view the images on an electronic display, especially the dark areas of the image, under strong sunlight.

Histogram Equalization (HE) is a widely used image processing method that can re-map the pixels of an image so as to produce a new image with better contrast. However, the average brightness of an image is sometimes greatly affected by Histogram Equalization.

Therefore, the present invention provides a dynamic range-adjustment technology that can improve the contrast, the visibility of the image under sunlight, and in the meantime, keep the average brightness of the image as close to the original as possible.

### BRIEF SUMMARY OF THE INVENTION

The present invention provides a dynamic range-adjustment apparatus, comprising: an input unit for receiving an original image; an histogram equalization unit, coupled to the input unit, for performing contrast enhancement on the original image to produce a contrast-enhanced image; a factor-determination unit, coupled to the input unit and the histogram equalization unit, for determining a first factor based on the gray level of a pixel of the original image and the tone of the corresponding pixel of the contrast-enhanced image; and an adjustment unit, coupled to the input unit, the histogram equalization unit and the factor-determination unit, for blending the original image and the contrast-enhanced image based on the first factor.

The present invention also provides a dynamic range-adjustment method, comprising the steps of: receiving an original image; performing contrast enhancement on the original image to produce a contrast-enhanced image; determining a first factor based on the gray level of a pixel of the original image and the tone of the corresponding pixel of the contrast-enhanced image; and blending the original image and the contrast-enhanced image based on the first factor.

### BRIEF DESCRIPTION OF THE DRAWINGS

The present invention can be more fully understood by reading the subsequent detailed description and examples with references made to the accompanying drawings, wherein:

FIG. 1 is a schematic diagram of a dynamic range-adjustment apparatus according to an embodiment of the present invention.

FIG. 2 shows a cumulated histogram of the contrast-enhanced image produced by the histogram equalization unit.

FIG. 3 is a flowchart of the dynamic range-adjustment method according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### Dynamic Range-Adjustment Apparatus

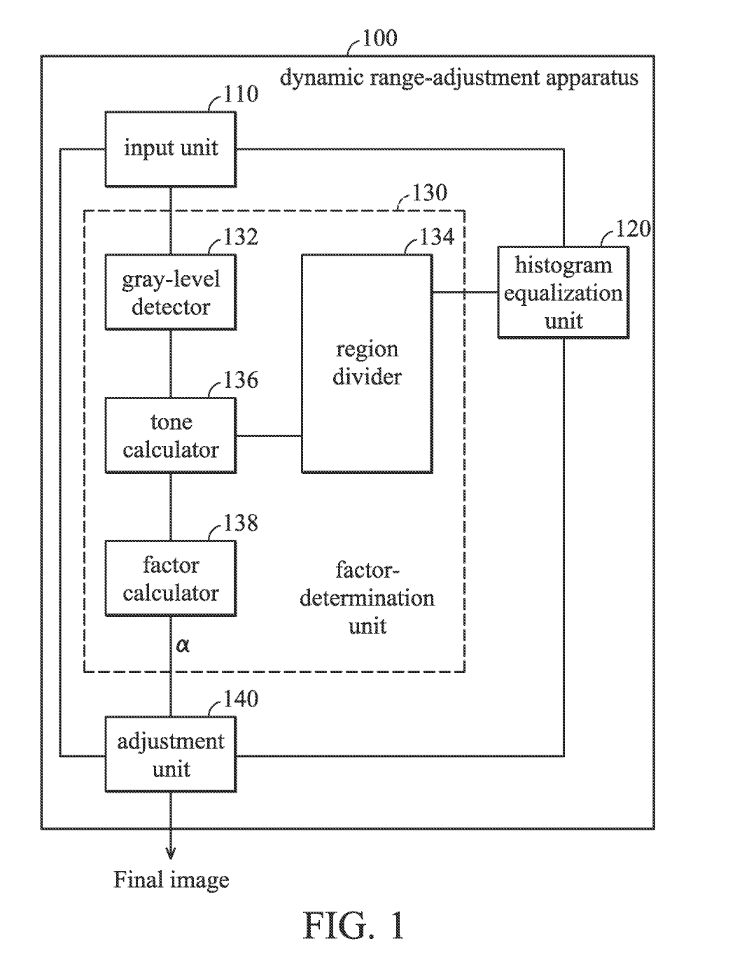

FIG. 1 is a schematic diagram of a dynamic range-adjustment apparatus according to an embodiment of the present invention. The dynamic range-adjustment apparatus 100 of the present invention at least comprises an input unit 110, a histogram equalization unit 120, a factor-determination unit 130 and an adjustment unit 140. These components will be described in detail in the following.

The input unit 110 of the present invention is used to receive an original image. In some embodiments, the histogram equalization unit 120 or the other components can only process the image through a particular data format (for example, HSV format) other than that of the original image (for example, RGB format). To deal with this, the input unit 110 of the present invention can further comprise a data-format converter (for example, a RBG-to-HSV converter), so as to convert the original data format (RBG format) of the original image into the new data format (HSV format). Note that in other embodiments, the present invention should not be limited thereto.

The histogram equalization unit 120 of the present invention is coupled to the input unit 110, and used to convert the original image into a contrast-enhanced image by using the histogram equalization technology. Since those skilled in the art can use the histogram equalization technology to process images in various manners, the details of the histogram equalization procedure will not be further discussed. Basically, the image produced by the histogram equalization unit 120 has better contrast, but its average brightness may be seriously affected.

In order to keep the average brightness as close to the original as possible, the present invention provides an adjustment unit 140 to synthesize the original image and the contrast-enhanced image to establish a final image which has suitable visibility to the human eye so that one can view the image under strong sunlight. The synthesizing procedure is performed by blending the original image received by the input unit 110 and the contrast-enhanced image produced by the histogram equalization unit 120 according to the following formula:

final_value=α×original_value+(1−α)×modified_value,

wherein the symbols “final_value”, “original_value”, and “modified_value” respectively represent the brightness values of the final image, the original image, and the contrast-enhanced image; and the symbol “α” represents a specific factor of the present invention, which will be described in detail below.

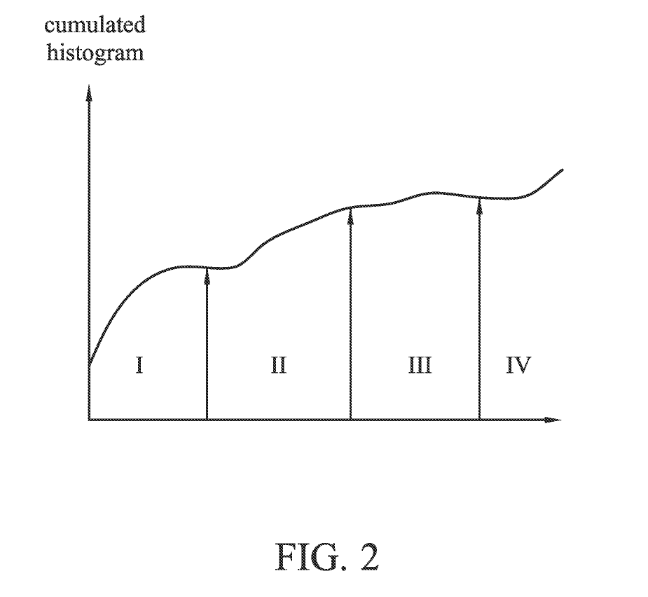

The specific factor “α” is determined by the factor-determination unit 130 of the present invention. Specifically, the factor “α” is calculated based on the gray level of a pixel of the original image and the “tone” of the corresponding pixel of the contrast-enhanced image. In some embodiments, the factor-determination unit 130 of the present invention further comprises a gray-level detector 132, a region divider 134, a tone calculator 136, and a factor calculator 138. The gray-level detector 132 is coupled to the input unit 110, and is used to detect the gray level for each pixel of the original image. The region divider 134 is coupled to the histogram equalization unit 120, and is used to divide the histogram of the contrast-enhanced image produced by the histogram equalization unit 120 into several regions. For example, the histogram is a cumulated histogram as shown in FIG. 2, and, the cumulated histogram is divided into 4 sections so that each section may has 25% of the pixels of entire contrast-enhanced image. It is noted that the boundaries of the section can be adjusted for different situation. The tone detector 136 of the present invention is used to calculate the “tone” for each pixel of the contrast-enhanced image (for example, for the corresponding pixel of the contrast-enhanced image). The “tone” of the corresponding pixel, hereinafter, is defined as follows:

tone=(gray_value−region_bottom)/(region_upper−region_bottom)

wherein the symbol “gray_value” represents the gray level of the pixel of the original image; the “region_upper” and the “region_bottom” respectively represent the upper and bottom limits of the region where the pixel is located.

Then, the factor calculator 138 of the present invention can calculate the factor α. In an embodiment, the factor α for the pixel can be calculated according to the following formula:

α=tone×(gray_max−gray_value)/(gray_upper−gray_bottom)

wherein the symbol “gray_max” represents the maximum gray value of all the pixels of the original image; and the symbol “gray_upper” and “gray_bottom” respectively represent the upper and bottom limits of the gray-level range (for example, 0˜256). It can be found that the magnitude factor α defines the extent that the pixel should be brightened to.

Through the procedures described above, the original image received by the input unit 110 and the contrast-enhanced image produced by the histogram equalization unit 120 can be synthesized into a final image, where the contrast and the visibility under sunlight are improved while the average brightness of the image is kept as close to the original as possible.

In order to be more adaptive to the light intensity of the external environment, in some embodiments, the dynamic range-adjustment apparatus of the present invention further comprises a light sensor (not shown) for sensing the light intensity of the external environment, and the factor-determination unit 130 further determines another factor β according to the light intensity sensed by the light sensor. In this manner, the formula for blending the original image and the contrast-enhanced image can be revised as follows:

final_value=β×original_value+(1−β)×[α×original_value+(1−α)×modified_value].

Those skilled in the art can appropriately employ and modify the factors α and β according to the spirit of the present invention.

### Dynamic Range-Adjustment Apparatus

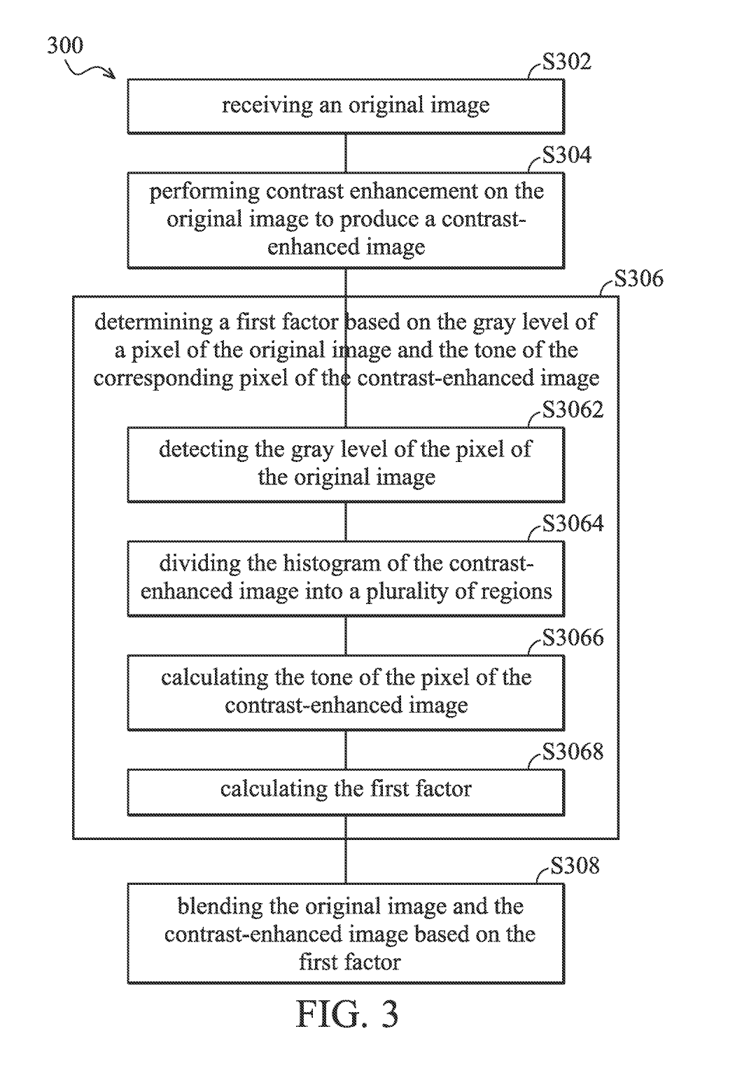

In addition to the dynamic range-adjustment apparatus, the present invention further provides a dynamic range-adjustment method. FIG. 3 is a flowchart of the dynamic range-adjustment method according to an embodiment of the present invention. The dynamic range-adjustment method 300 comprises: in step S302, receiving an original image; in step S304, performing contrast enhancement on the original image to produce a contrast-enhanced image; in step S306, determining a first factor based on the gray level of a pixel of the original image and the tone of the corresponding pixel of the contrast-enhanced image; and in step S308, blending the original image and the contrast-enhanced image based on the first factor.

In some embodiments, the dynamic range-adjustment method 300 further comprises converting the data format of the original image, for example, from a RGB data format to a HSV data format.

In some embodiments, step 306 further comprises: in step S3062, detecting the gray level of the pixel of the original image; in step S3064, dividing the histogram of the contrast-enhanced image into a plurality of regions; in step S3066, calculating the tone of the pixel of the contrast-enhanced image; and in step S3068, calculating the first factor. The tone of the pixel of the contrast-enhanced image can be defined in step S3066 as follows:

tone=(gray_value−region_bottom)/(region_upper−region_bottom),

wherein the symbol “gray_value” represents the gray level of the pixel of the original image; and the “region_upper” and the “region_bottom” respectively represent the upper and bottom limits of the region where the pixel is located. And, the first factor can be calculated in step S3068 according to the following formula:

α=tone×(gray_max−gray_value)/(gray_upper−gray_bottom)

wherein the symbol “gray_max” represents the maximum gray value of all the pixels of the original image; and the symbol “gray_upper” and “gray_bottom” respectively represent the upper and bottom limits of the gray-level range.

In some embodiments, the dynamic range-adjustment method 300 further comprises the steps of: sensing the light intensity of the external environment and determining a second factor β according to the light intensity sensed by the light sensor. In this embodiment, the original image and the contrast-enhanced image can be blended according to the following formula:

final_value=β×original_value+(1−β)×[α×original_value+(11−α)×modified_value]

wherein the symbols “final_value”, “original_value”, and “modified_value” respectively represent the brightness values of the final image, the original image, and the contrast-enhanced image; the symbol “α” represents the first factor; and the symbol “β” represents the second factor. Those skilled in the art can appropriately employ and modify the factors α and β according to the spirit of the present invention.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dynamic range-adjustment apparatus, comprising:
an input unit for receiving an original image;
an histogram equalization unit, coupled to the input unit, for performing contrast enhancement on the original image to produce a contrast-enhanced image;
a factor-determination unit, coupled to the input unit and the histogram equalization unit, for determining a first factor based on the gray level of a pixel of the original image and the tone of the corresponding pixel of the contrast-enhanced image; and
an adjustment unit, coupled to the input unit, the histogram equalization unit and the factor-determination unit, for blending the original image and the contrast-enhanced image based on the first factor.

2. The dynamic range-adjustment apparatus as claimed in claim 1, wherein the adjustment unit blends the original image and the contrast-enhanced image according to the following formula:
final_value=α×original_value+(1−α)×modified_value,
wherein the symbols “final_value”, “original_value”, and “modified_value” respectively represent the brightness values of the final image, the original image, and the contrast-enhanced image; and the symbol “α” represents the first factor.

3. The dynamic range-adjustment apparatus as claimed in claim 1, wherein the input unit further comprises a data-format converter.

4. The dynamic range-adjustment apparatus as claimed in claim 3, wherein the data-format converter is a RGB-HSV converter.

5. The dynamic range-adjustment apparatus as claimed in claim 1, wherein the factor-determination unit further comprises: a gray-level detector for detecting the gray level of the pixel of the original image.

6. The dynamic range-adjustment apparatus as claimed in claim 1, wherein the factor-determination unit further comprises: a region divider for dividing the histogram of the contrast-enhanced image into a plurality of regions.

7. The dynamic range-adjustment apparatus as claimed in claim 6, wherein the factor-determination unit further comprises: a tone detector for calculating the tone of the pixel of the contrast-enhanced image, and the tone of the pixel of the contrast-enhanced image is defined as follows:
tone=(gray_value−region_bottom)/(region_upper−region_bottom),
wherein the symbol “gray_value” represents the gray level of the pixel of the original image; and the “region_upper” and the “region_bottom” respectively represent the upper and bottom limits of the region where the pixel is located.

8. The dynamic range-adjustment apparatus as claimed in claim 7, wherein the factor-determination unit further comprises: a factor calculator for calculating the first factor according to the following formula:
α=tone×(gray_max−gray_value)/(gray_upper−gray_bottom)
wherein the symbol “gray_max” represents the maximum gray value of all the pixels of the original image; and the symbol “gray_upper” and “gray_bottom” respectively represent the upper and bottom limits of the gray-level range.

9. The dynamic range-adjustment apparatus as claimed in claim 1, further comprising a light sensor for sensing the light intensity of the external environment.

10. The dynamic range-adjustment apparatus as claimed in claim 9, wherein the factor-determination unit determines a second factor β according to the light intensity sensed by the light sensor.

11. The dynamic range-adjustment apparatus as claimed in claim 10, wherein the adjustment unit blends the original image and the contrast-enhanced image according to the following formula:
final_value=β×original_value+(1−β)×[α×original_value+(1−α)×modified_value]
wherein the symbols “final_value”, “original_value”, and “modified_value” respectively represent the brightness values of the final image, the original image, and the contrast-enhanced image; the symbol “α” represents the first factor; and the symbol “β” represents the second factor.

12. A dynamic range-adjustment method, comprising the steps of:
receiving an original image;
performing contrast enhancement on the original image to produce a contrast-enhanced image;
determining a first factor based on the gray level of a pixel of the original image and the tone of the corresponding pixel of the contrast-enhanced image; and
blending the original image and the contrast-enhanced image based on the first factor.

13. The dynamic range-adjustment method as claimed in claim 12, wherein the original image and the contrast-enhanced image are blended according to the following formula:
final_value=α×original_value+(1−α)×modified_value,
wherein the symbols “final_value”, “original_value”, and “modified_value” respectively represent the brightness values of the final image, the original image, and the contrast-enhanced image; and the symbol “α” represents the first factor.

14. The dynamic range-adjustment method as claimed in claim 12, further comprising converting the data format of the original image.

15. The dynamic range-adjustment method as claimed in claim 14, wherein the data format is converted from a RGB data format to a HSV data format.

16. The dynamic range-adjustment method as claimed in claim 12, wherein the step of determining a first factor further comprises:
detecting the gray level of the pixel of the original image.

17. The dynamic range-adjustment method as claimed in claim 12, wherein the step of determining a first factor further comprises:
dividing the histogram of the contrast-enhanced image into a plurality of regions.

18. The dynamic range-adjustment method as claimed in claim 17, wherein the step of determining a first factor further comprises:
calculating the tone of the pixel of the contrast-enhanced image, and the tone of the pixel of the contrast-enhanced image is defined as follows:
tone=(gray_value−region_bottom)/(region_upper−region_bottom),
wherein the symbol “gray_value” represents the gray level of the pixel of the original image; and the “region_upper” and the “region_bottom” respectively represent the upper and bottom limits of the region where the pixel is located.

19. The dynamic range-adjustment method as claimed in claim 18, wherein the step of determining a first factor further comprises:
calculating the first factor according to the following formula:
α=tone×(gray_max−gray_value)/(gray_upper−gray_bottom)
wherein the symbol “gray_max” represents the maximum gray value of all the pixels of the original image; and the symbol “gray_upper” and “gray_bottom” respectively represent the upper and bottom limits of the gray-level range.

20. The dynamic range-adjustment method as claimed in claim 12, further comprising:
sensing the light intensity of the external environment.
determining a second factor β according to the light intensity sensed by the light sensor; and
blending the original image and the contrast-enhanced image according to the following formula:
final_value=β×original_value+(1−β)×[α×original_value+(1−α)×modified_value]
wherein the symbols “final_value”, “original_value”, and “modified_value” respectively represent the brightness values of the final image, the original image, and the contrast-enhanced image; the symbol “α” represents the first factor; and the symbol “β” represents the second factor.
